(19) United States
(12) Patent Application Publication
(10) Pub. No.: US 2014/0200996 A1
(43) Pub. Date: Jul. 17, 2014

(54) INFORMATION DISTRIBUTION DEVICE AND INFORMATION DISTRIBUTION METHOD

(71) Applicant: YAHOO JAPAN CORPORATION, Tokyo (JP)

(72) Inventor: Toru HOTTA, Tokyo (JP)

(73) Assignee: YAHOO JAPAN CORPORATION, Tokyo (JP)

(21) Appl. No.: 14/152,198

(22) Filed: Jan. 10, 2014

(30) Foreign Application Priority Data
Jan. 11, 2013 (JP) 2013-003171

(51) Int. Cl. G06Q 30/02

(52) U.S. Cl. CPC G06Q 30/0255; G06Q 30/0277; G06Q 30/0273
USPC 705/14.53; 705/14.73

(57) ABSTRACT

An advertising distribution device 1 has a detection unit P1 for detecting that a banner image B is selected, an acquisition unit P2 for acquiring attribute information F1 about the terminal 2, and a distribution unit P4 for changing a distribution mode depending on the attribute information F1 and distributing advertising information A after selection of the banner image B.

### CROSS-REFERENCE TO RELATED APPLICATIONS

The present application claims priority to and incorporates by reference the entire contents of Japanese Patent Application No. 2013-003171 filed in Japan on Jan. 11, 2013.

### BACKGROUND OF THE INVENTION

1. Field of the Invention

The present invention relates to an information distribution device and an information distribution method. In particular, the present invention relates to an information distribution device etc. for distributing advertising information to a terminal.

2. Description of the Related Art

Conventionally, advertising information distribution has been performed to a terminal, such as a mobile phone and a personal computer. The advertising information distribution displays an advertising image, such as a banner image, on which a link is provided to a detailed information page on which more detailed advertising information is posted. When a user clicks the banner image in the terminal, content of the detailed information page of the link destination is transmitted to the terminal, and the detailed advertising information is displayed in the terminal.

The click of the advertising image in the terminal is detected by an advertising distribution server that manages advertising distribution. The advertising distribution server generates billing information for each advertiser and implements billing management of the advertiser based on management information such as how many times and which advertising image is clicked.

A proposal has been made to temporarily display content of an intermediate page instead of immediately displaying content of the detailed information page in the terminal when the advertising image is clicked. (For example, refer to Japanese Laid-open Patent Publication No. 2012-242976.) This is adapted to temporarily display the content of the intermediate page in the terminal after the advertising image is clicked, and to transmit information about an advertiser server, which is a detailed information page, to the terminal when a “button for moving to the advertiser server” in the intermediate page is clicked.

When the intermediate page is to be displayed upon clicking of the advertising image, a user's intention to move to the detailed information page can be confirmed in the intermediate page. This can prevent the detailed information page from being accidentally displayed in the terminal regardless of the user's intention. However, when the intermediate page is displayed by each click of the advertising image, a “troublesome” or “complicated” impression is given to a user who has an intention of moving to the detailed information page. In addition, it takes longer time until the detailed information page is displayed, and it is difficult to satisfy needs of the user who requires the detailed information quickly.

Preferably provision is made to automatically estimate whether the user is a user who requires detailed information quickly, or the user is a user whose intention of detailed information display (moving to the detailed information page) is to be confirmed in the intermediate page, and to provide information different for each user to the terminal after the advertising image is clicked.

In order to solve the above-described problems, an information distribution device according to an exemplary aspect of the present invention includes: a detection unit for detecting that predetermined display information displayed on a display screen of a terminal is selected; a distribution unit for distributing distribution information to the terminal when it is detected that the predetermined display information is selected; an acquisition unit for acquiring attribute information related to the terminal from the terminal, the attribute information including at least a browsing history of an Internet site by the terminal; a classification criterion that is a determination criterion for classifying the terminal; and a classification unit for classifying the terminal into at least a first classification and a second classification based on a comparison between the attribute information and the classification criterion, wherein the distribution unit distributes first distribution information as the distribution information to the terminal when the terminal is classified into the first classification, and distributes second distribution information different from the first distribution information as the distribution information to the terminal when the terminal is classified into the second classification.

An information distribution method according to another exemplary aspect of the present invention causes a computer to perform the steps of: detecting that predetermined display information displayed on a display screen of a terminal is selected; distributing distribution information to the terminal when it is detected that the predetermined display information is selected; acquiring attribute information related to the terminal from the terminal, the attribute information including at least a browsing history of an internet site by the terminal; and classifying the terminal into at least a first classification and a second classification based on a comparison between the attribute information and a classification criterion that is a determination criterion for classifying the terminal, wherein the step by the distribution unit distributes the first distribution information as the distribution information to the terminal when the terminal is classified into the first classification, and distributes second distribution information different from the first distribution information as the distribution information to the terminal when the terminal is classified into the second classification.

Further objectives or other features of the present invention will become apparent from the following description of the preferred embodiment with reference to the accompanying drawings.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an overall configuration diagram of an advertising system according to an embodiment;

FIG. 2 illustrates an example of a site page of a news site that a news server according to the embodiment transmits to a terminal;

FIG. 3 is a block diagram illustrating an outline of an internal configuration of an advertising distribution device according to the embodiment;

FIG. 4 is a data structure diagram of an advertising information database according to the embodiment;

FIG. 5 is a data structure diagram of a billing information database according to the embodiment;

FIG. 6 is an example of a display of detailed information according to the embodiment;

FIG. 7 is an example of a display of intermediate page information according to the embodiment;

FIG. 8 is a flow chart illustrating an advertising information distribution process according to the embodiment; and

FIG. 9 is an example of a display of intermediate page information according to a first variation.

### DETAILED DESCRIPTION OF THE PREFERRED EMBODIMENTS

### Embodiment

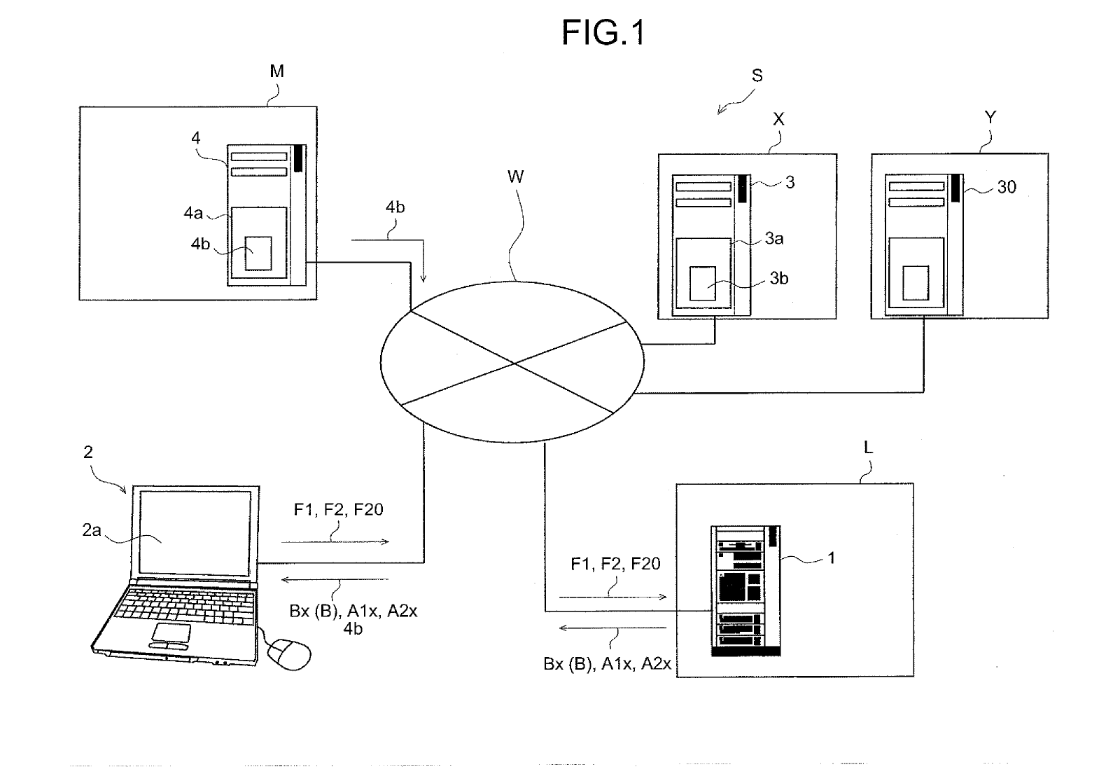

An embodiment will be described below with reference to the accompanying drawings. FIG. 1 is an overall configuration diagram of an advertising system S according to the embodiment. The advertising system S includes transmission and reception of various information among an advertising distribution device (an information distribution device, a computer) 1, a terminal 2, an advertiser server 3, and a media server 4.

Terminal 2

The terminal 2 is a terminal owned or managed by a user. For example, a mobile phone, a personal computer, a smart phone, a tablet terminal, etc. are applicable. The terminal 2 has an arithmetic processing unit and a memory therein, and a display screen 2a and a keyboard (an information input unit). The terminal 2 is connected to the Internet W wirelessly or with a wire, and can transmit and receive information with the advertising distribution device 1, the advertiser server 3, and the media server 4. In the present embodiment, the terminal 2 is a personal computer (PC).

In the terminal 2, the use of an application program, such as, for example, an Internet browser, enables web site pages of various Internet sites to be browsed. Attribute information F1 is stored in the memory of the terminal 2. The attribute information F1 refers to information related to a site page of an Internet site browsed by the user in the past using the terminal 2, and information related to a product etc. purchased by the user in the past in an Internet shop etc. using the terminal 2 (action history information). For example, cookie information stored in the terminal 2 may be the attribute information F1.

Advertiser Server 3

The advertiser server 3 is a device (a server computer) owned or managed by an advertiser X who desires advertising distribution to the terminal 2 via the Internet W. The advertiser server 3 has a memory therein as a storage device, and stores information about an advertiser site 3a as an Internet site in the memory.

The advertiser site 3a includes one or more site pages, in which detailed information 3b regarding the advertiser's business and a product are described. The detailed information 3b can be transmitted via the Internet W. Specifically, the detailed information 3b is to be transmitted to the terminal 2 via the Internet W in response to a request signal from the terminal 2 to the advertiser server 3, and the detailed information 3b is to be displayed on the display screen 2a of the terminal 2.

An advertiser server 30 owned or managed by an advertiser Y different from the advertiser X's advertiser server 3 may be connected to the Internet W. The advertiser server 30 has a function similar to that of the advertiser server 3.

Media Server 4

The media server 4 is a device (a server computer) that transmits various content information to the terminal 2 via the Internet W, and is a device owned or managed by a media distributor M. The media server 4 has a memory therein as a storage device, and stores information about a media site 4a as an Internet site in the memory.

The media server 4 includes one or more site pages, in which various content information 4b is described. News information, portal site information, shopping site information, blog information, etc. can be illustrated as the content information 4b. The present embodiment describes news information as an example of the content information 4b. Specifically, the news information 4b is to be transmitted to the terminal 2 via the Internet W in response to a request signal from the terminal 2 to the news server 4 as the media server, and the news information 4b is to be displayed on the display screen 2a of the terminal 2.

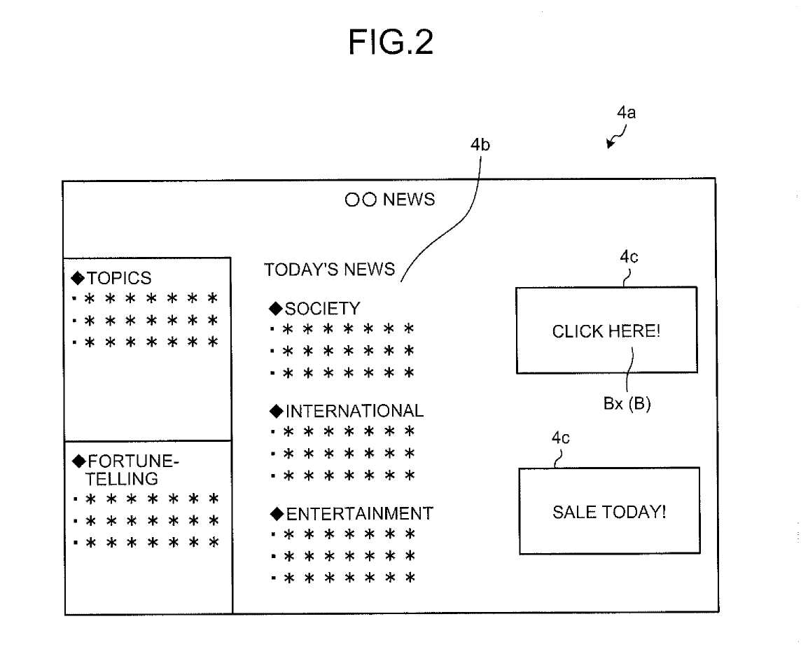

FIG. 2 illustrates an example of a site page of the news site (media site) 4a transmitted by the news server 4 to the terminal 2. FIG. 2 illustrates a display layout in a case of being displayed on the display screen 2a of the terminal 2. The news information 4b is described in the site page of the news site 4a.

An advertisement space 4c is disposed in a part of the site page. A banner image (predetermined display information) B distributed from the advertising distribution device 1 is displayed in the advertisement space 4c. The banner image B is an advertising image for attracting an interest of the user who looks at the display screen 2a of the terminal 2, and is image data for introducing a product etc. of the advertiser.

The banner image B displays merely an outline of the advertising information, and displays, for example, “Click here!” etc., and is adapted to urge a user who wants to know more detailed information about the product etc. of the advertiser to click (select) the banner image B with input means, such as a mouse.

When the banner image B is clicked (selected) by the user, selection information F2 indicating the selection of the banner image B is to be transmitted from the terminal 2 to the advertising distribution device 1. When the selection information F2 is received, the advertising distribution device 1 selectively distributes, to the terminal 2, detailed information introducing the product etc. of the advertiser (first distribution information), or intermediate page information for confirming the user's intention of whether to browse the detailed information (second distribution information).

Advertising Distribution Device 1

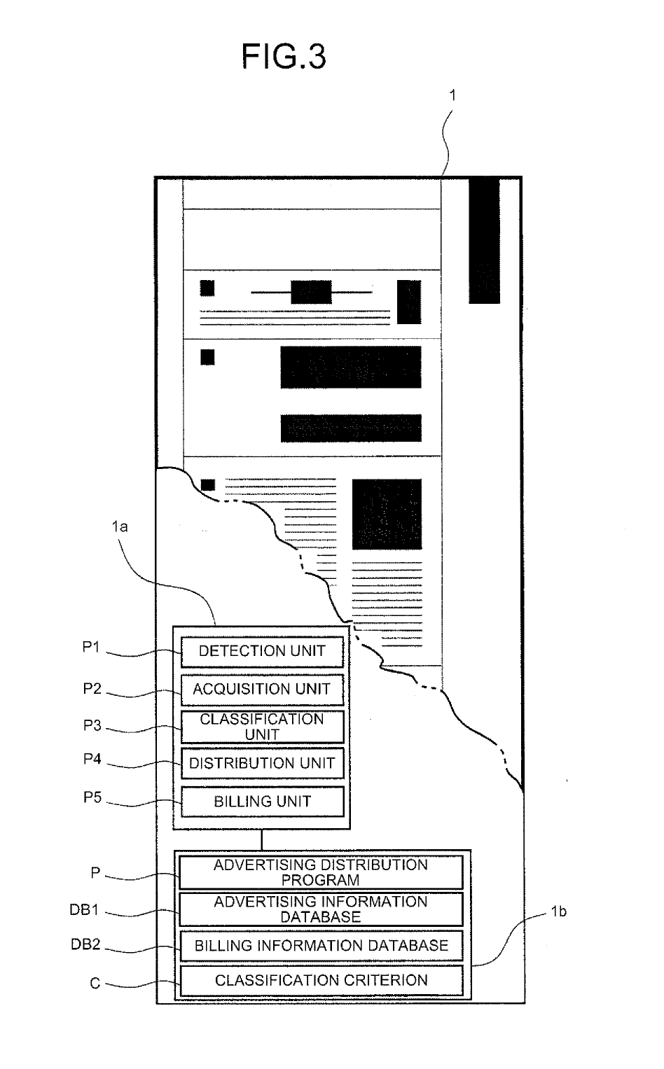

The advertising distribution device 1 is a computer for distributing the banner image (display information) B and the advertising information (distribution information) A to the terminal 2, and is a device owned or managed by an advertising company L. FIG. 3 is a block diagram illustrating an outline of an internal configuration of the advertising distribution device 1. The advertising distribution device 1 has a central processing unit (CPU) 1a as a main portion of the computer and a memory 1b as a storage device therein. An advertising distribution program (an information distribution program) P, an advertising information database (a distribution information database) DB1, and a billing information database DB2 are stored in the memory 1b. A classification criterion C is also stored in the memory 1b.

The advertising distribution program P is a program that causes the CPU 1a to execute arithmetic processing and causes the CPU 1a to perform functions as a detection unit P1, an acquisition unit P2, a classification unit P3, a distribution unit P4, and a billing unit P5. The classification criterion C is a determination criterion for classifying the terminal 2 based on the attribute information F1 acquired from the terminal 2. Details of the functions of each unit performed by the CPU 1a with the advertising distribution program P and the classification criterion C will be described later.

Advertising Information Database DB1

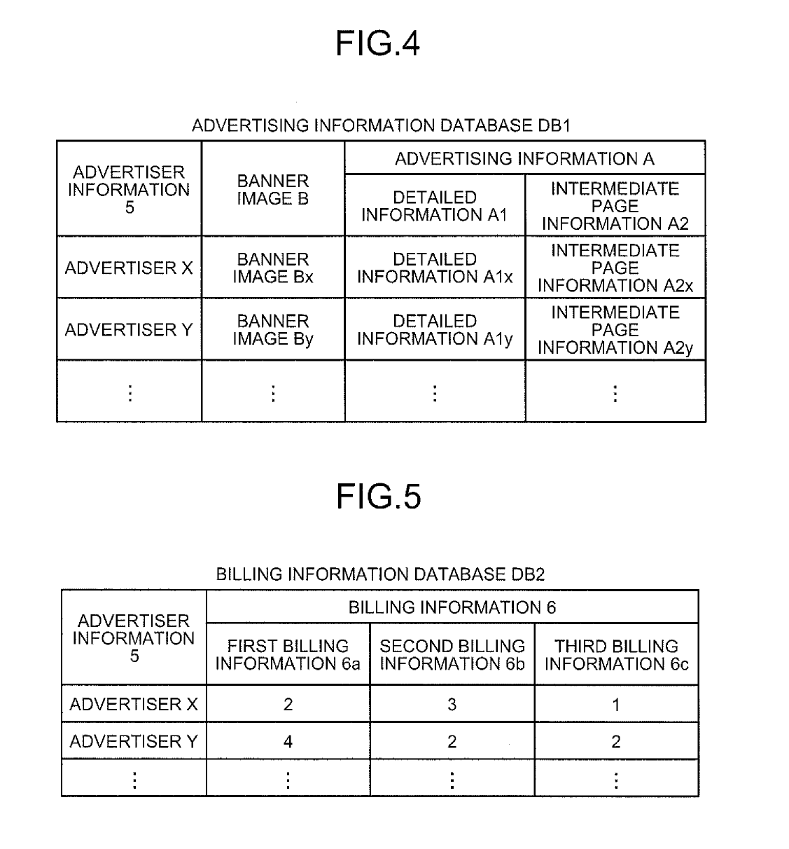

FIG. 4 is a data structure diagram of the advertising information database DB1. The advertising information database DB1 is built by establishing an association between the banner image B and advertising information A for each advertiser information 5. The advertising information A has detailed information (first distribution information) A1 and intermediate page information (second distribution information) A2. In the example of FIG. 4, a banner image Ex, detailed information A1x, and intermediate page information A2x are associated for the advertiser X, and a banner image By, detailed information A1y, and intermediate page information A2y are associated for the advertiser Y. The banner image B, the detailed information A1, and the intermediate page information A2 are information of which the advertiser desires distribution to the terminal, and are created in advance based on an agreement between the advertisers X, Y and the advertising company L, and stored in the advertising information database DB1.

This intermediate page information A2 may be generated by, for example, having the advertiser enter required information in a template prepared by the advertising distribution device 1. That is, the intermediate page information (A2x, A2y) may be generated and stored in the advertising information database DB1 by a site page for creating the intermediate page information being prepared in the advertising distribution device 1, the advertiser (X, Y) accessing the site for creating the intermediate page information from the advertiser server (3, 30) or other computers and entering required information in the template displayed in the site page.

The intermediate page information (A2x, A2y) may be generated by the advertising distribution device 1 automatically doing the layout based on various information (text information, image information) entered by the advertiser (X, Y). The advertising distribution device 1 may access the advertiser server 3, automatically extract the detailed information 3b in the advertiser site 3a, and the intermediate page information A2x may be automatically generated based on the extracted information.

When the detailed information in the advertiser site is automatically extracted and the intermediate page information is automatically generated, for example, image information may be automatically extracted from the detailed information in the advertiser site and included in the intermediate page information. An abstract may be automatically created based on text information in the detailed information and the created abstract may be included in the intermediate page information by performing a morphological analysis of the detailed information in the advertiser site. Of course, such automatic extraction of image information and automatic abstract creation by the morphological analysis can also be applied to automatic generation of the intermediate page information based on various information entered by the advertiser.

The banner image B is image information that strongly attracts an interest of the user with minimum information. Information such as a so-called catchphrase can be illustrated. For example, words, such as “Click here!”, may be described. The detailed information A1 is information that introduces and describes in detail a product etc. of the advertiser X. For example, a product lineup of the advertiser X, and an image, performance, pricing information, etc. of the product may be described. The intermediate page information A2 is information that has an intermediate amount of information between the banner image B and the detailed information A1. For example, content introducing an outline of the product etc. of the advertiser X and information describing words, such as “Click here for details”, for confirming the user's intention of whether the user desires to display the detailed information A1 are included. When the intermediate page information A2 is clicked (selected), the detailed information A1 is to be displayed.

Billing Information Database DB2

FIG. 5 is a data structure diagram of the billing information database DB2. The billing information database DB2 is built by establishing an association between the advertiser information 5 and billing information 6. The billing information 6 has first billing information 6a, second billing information 6b, and third billing information 6c.

The billing unit P5 generates the billing information 6 every time the distribution unit P4 to be described later distributes the advertising information A. The distribution unit P4 repeatedly distributes the advertising information A, such as the detailed information A1 and the intermediate page information A2, to the terminal 2 and other terminals. When the billing unit P5 generates the first billing information 6a in relation to the advertiser X, the first billing information 6a is associated with the advertiser x. Every time the first billing information 6a is generated, the number of generation is counted in a column of the first billing information 6a related to the advertiser X in the billing information database DB2 of FIG. 5. Similarly, when the billing unit P5 generates the second billing information 6b (the third billing information 6c) in relation to the advertiser X, the second billing information 6b (the third billing information 6c) is associated with the advertiser X, and the number of generation is counted in a column of the second billing information 6b (the third billing information 6c) related the advertiser X in the billing information database DB2.

FIG. 5 illustrates an example in which, in relation to the advertiser X, the first billing information 6a is generated twice, the second billing information 6b is generated three times, and the third billing information 6c is generated once. The number of generation of the third billing information 6c related to a specified advertiser does not become larger than the number of generation of the second billing information 6b.

The CPU 1a as a main portion of the advertising distribution device 1 functions as the detection unit P1, the acquisition unit P2, the classification unit P3, the distribution unit P4, and the billing unit P5 by executing the advertising distribution program P.

Detection Unit P1

The detection unit P1 has a function to detect that the banner image B is clicked (selected) by the terminal 2. When the terminal 2 accesses the news server 4 via the Internet W, the site page of the news site 4a is displayed on the display screen 2a of the terminal 2. The news information 4b and the advertisement space 4c are disposed in the site page, and the banner image B is displayed in the advertisement space 4c.

The banner image B is distributed by the distribution unit P4 of the advertising distribution device 1 based on the advertising information database DB1. The advertising distribution device 1 selects one of the banner images Bx, By out of the advertising information database DB1 based on a predetermined algorithm, and distributes the banner image to the terminal 2. In the present embodiment, the banner image Bx of the advertiser X is selected and distributed to the terminal 2.

The banner image Bx has a display such as “Click here!” so as to attract the user's interest. When the user clicks the banner image Bx in the terminal 2, the selection information F2 indicating the click is to be transmitted from the terminal 2 to the advertising distribution device 1, and detected by the detection unit P1.

The detection unit P1 also has a function to detect selection information F20 transmitted from the terminal 2 when the intermediate page information A2x described later is displayed on the display screen 2a and the intermediate page information A2x is clicked (selected) by the user of the terminal 2.

Acquisition Unit P2

The acquisition unit P2 has a function to acquire the attribute information F1 related to the terminal 2. The attribute information F1 is information used for estimating the degree of the interest of the user of the terminal 2 in a product etc. related to the advertisement of the advertiser X. The attribute information F1 is, for example, past Internet site browsing history information regarding the terminal 2, and purchasing history information about a product purchased by the user in the past using the terminal 2.

How much interest the user of the terminal 2 takes in the product etc. related to the advertisement of the advertiser X can be estimated based on the history information. In other words, a determination can be made whether the detailed information A1x should be distributed or the intermediate page information A2x should be distributed based on the attribute information F1 after the user of the terminal 2 selects the banner image Ex.

The attribute information F1 may be cookie information stored in the terminal 2. In addition, when the advertising distribution device 1 accumulates past action history information of the terminal 2 (such as Internet site browsing history information and purchasing history information) in association with the terminal 2 in advance, the action history information of the terminal 2 in the advertising distribution device 1 may be used as the attribute information F1. Both of the cookie information from the terminal 2 and the action history information of the terminal 2 in the advertising distribution device 1 may, of course, be used as the attribute information F1. The acquisition unit P2 acquires the attribute information F1 in the terminal 2 and the advertising distribution device 1, and sends the attribute information F1 to the classification unit P3.

This attribute information F1 may, of course, be associated with the terminal 2, and stored as a user database in a device different from the terminal 2 or the advertising distribution device 1. In this case, the acquisition unit P2 acquires the attribute information F1 related to the terminal 2 from the user database in the different device.

Classification Unit P3

The classification unit P3 has a function to classify the terminal 2 into a first classification and a second classification based on a comparison between the attribute information F1 and the classification criterion C. The classification unit P3 compares the attribute information F1 and the classification criterion C when the attribute information F1 related to the terminal 2 is received from the acquisition unit P2. The classification criterion C is a criterion to determine whether to classify the terminal 2 into the first classification or the second classification.

For example, the classification criterion C may be a criterion to determine whether the attribute information F1 related to the terminal 2 has information regarding the purchasing history of the product of the advertiser X as past purchasing history information. In this case, when the attribute information F1 related to the terminal 2 has the information regarding the purchasing history of the product of the advertiser X as the past purchasing history information, the classification unit P3 classifies the terminal 2 into the first classification, and otherwise the classification unit P3 classifies the terminal 2 into the second classification.

In addition, for example, the classification criterion C may be a criterion to determine whether the attribute information F1 related to the terminal 2 has accessed the advertiser site 3a of the advertiser X in a most recent predetermined period (for example, one week etc.). In this case, when the attribute information F1 related to the terminal 2 has browsing history information indicating an access to the advertiser site 3a of the advertiser X within past one week, the classification unit P3 classifies the terminal 2 into the first classification, and otherwise the classification unit P3 classifies the terminal 2 into the second classification. The classification unit P3 sends a classification result regarding the terminal 2 to the distribution unit P4.

Distribution Unit P4

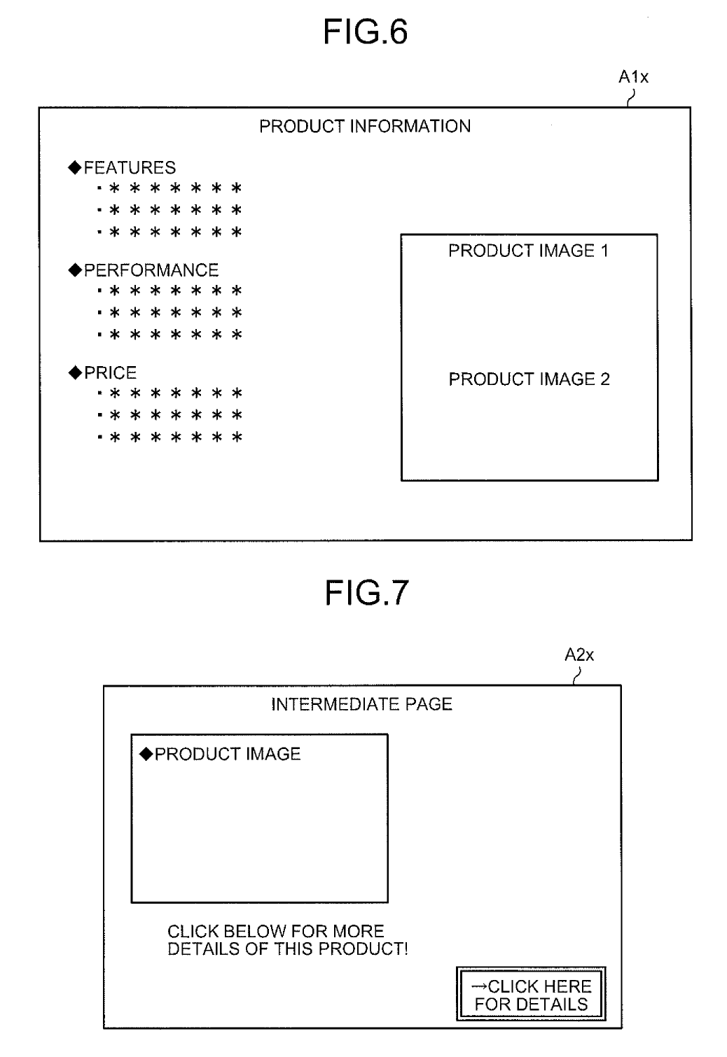

The distribution unit P4 has a function to change a distribution mode and distribute the distribution information based on the classification result by the classification unit P3 when the detection unit P1 detects that the banner image Bx is selected (that is, after the banner image Bx is clicked). The change of the distribution mode includes a case where the distribution information is changed based on the classification result and a case where it is changed whether the distribution information is to be distributed or not, based on the classification result. In the present embodiment, the distribution unit P4 distributes the detailed information A1x or the intermediate page information A2x to the terminal 2 depending on the classification result regarding the terminal 2. That is, when the classification result received from the classification unit P3 indicates that the terminal 2 is classified into the first classification, the detailed information A1x is distributed to the terminal 2 based on the advertising information database DB1. As illustrated in FIG. 6, the detailed information A1x regarding the product etc. of the advertiser X is displayed on the display screen 2a of the terminal 2. When the classification result received from the classification unit P3 indicates that the terminal 2 is classified into the second classification, the intermediate page information A2x, which is different from the detailed information A1x, is distributed to the terminal 2 based on the advertising information database DB1. As illustrated in FIG. 7, the intermediate page information A2x regarding the product etc. of the advertiser X is displayed on the display screen 2a of the terminal 2.

The detailed information A1x can thereby be distributed to the terminal 2 classified into the first classification immediately after the click of the banner image Bx based on an estimate that the user takes a strong interest in the product etc. of the advertiser X. The user who takes a strong interest in the product etc. of the advertiser X can be quickly provided with the detailed information A1x without taking time.

The intermediate page information A2x can be distributed to the terminal 2 classified into the second classification after the click of the banner image Bx based on an estimate that the user does not take a strong interest in the product etc. of the advertiser X. It is possible to confirm the intention of whether to display the detailed information A1x with a user whose intention of displaying the detailed information A1x is unknown.

The distribution unit P4 further has a function to distribute the detailed information A1x to the terminal 2 when the detection unit P1 detects the selection information F20 (that is, when the intermediate page information A2x is clicked (selected) in the terminal 2 to which the intermediate page information A2x is distributed). When the user who checks the intermediate page information A2x desires the detailed information A1x, the detailed information A1x can be quickly provided to the terminal 2 of the user.

Billing Unit P5

The billing unit P5 has a function to generate the billing information 6. Specifically, the billing unit P5 generates the first billing information 6a that indicates the first billing amount when the terminal 2 is classified into the first classification and the detailed information A1x is distributed to the terminal 2. The billing unit P5 generates the second billing information 6b that indicates the second billing amount when the terminal 2 is classified into the second classification and the intermediate page information A2x is distributed to the terminal 2. The billing unit P5 generates the third billing information 6c that indicates the third billing amount when the terminal 2 is classified into the second classification and the detailed information A1x is distributed to the terminal 2.

The first billing amount herein may be the sum of the second billing amount and the third billing amount. By making this setting, a billing amount in a case where the detailed information A1x is eventually distributed to the terminal 2 can be made a same amount regardless of whether the terminal 2 is classified into the first classification or the second classification. Fairness of a billing burden relative to advertising effectiveness can be assured.

For example, in the present embodiment, in a situation where the terminal 2 is classified into the first classification, when the banner image Bx is clicked, the detailed information A1x is distributed, and billing information of 100 yen is generated as the first billing information 6a. On the other hand, in a situation where the terminal 2 is classified into the second classification, when the banner image Bx is clicked, the intermediate page information A2x is distributed, and billing information of 20 yen, which is the amount of 20% of the first billing information 6a, is generated as the second billing information 6b. Subsequently, when the intermediate page information A2x is further clicked, the detailed information A1x is distributed, and billing information of 80 yen, which is remaining 80% of the first billing information 6a, is generated as the third billing information 6c.

When the billing unit P5 generates the billing information 6, the generated billing information 6 is stored in the billing information database DB2. The number of generation of each of the first billing information 6a, the second billing information 6b, and the third billing information 6c is stored in the billing information database DB2 for each advertiser (X, Y). The billing amount to the advertiser (X, Y) is totaled based on the number of generation of the billing information 6 in the billing information database DB2.

Advertising Information Distribution Process

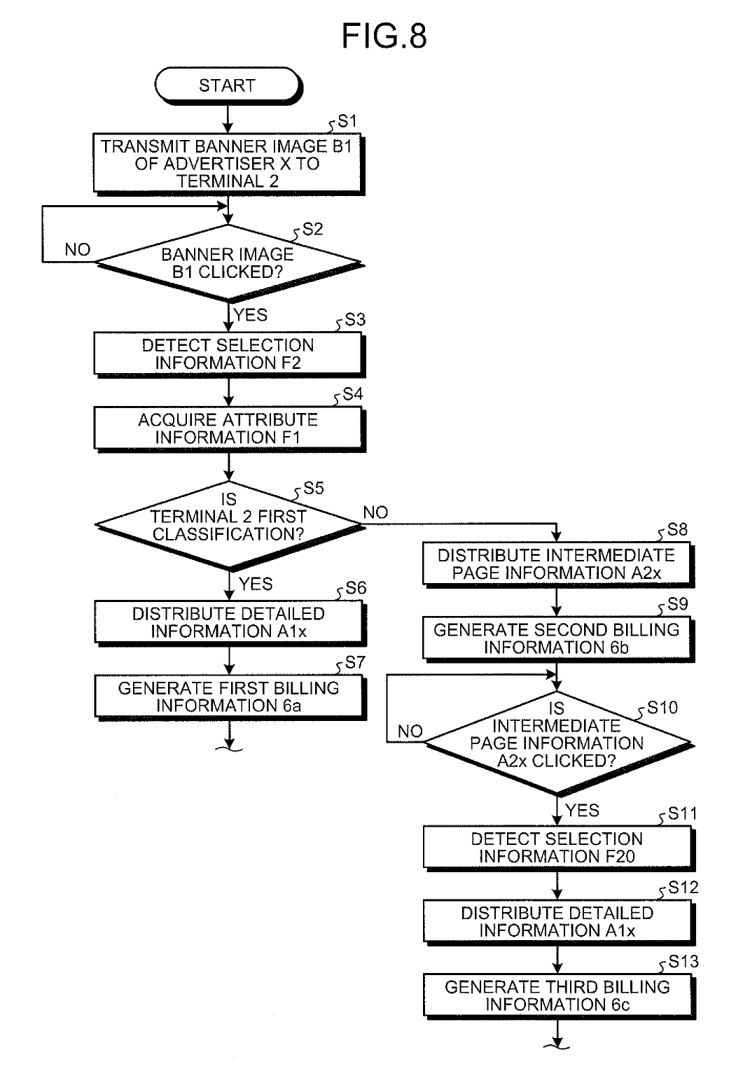

Next, an advertising information distribution process by the advertising distribution device 1 will be described with reference to a flow chart of FIG. 8. Although the following description uses an expression in which a subject is mainly the terminal 2, a user (a user, an owner, an administrator) who operates the terminal 2 exists as a matter of course. Accordingly, “the terminal 2 is (to the terminal 2, of the terminal 2)” is generally synonymous with “the user is (to the user, of the user)”.

When the terminal 2 accesses the news site 4a, the news server 4 transmits the news information 4b to the terminal 2, and the advertising distribution device 1 transmits the banner image B1 of the advertiser X to the terminal 2 (S1). When the terminal 2 clicks (selects) the banner image B1 (S2), the advertising distribution device 1 detects the selection information F2 thereof (S3). The advertising distribution device 1 acquires the attribute information F1 from the terminal 2 (S4). The advertising distribution device 1 classifies the terminal 2 into the first classification or the second classification based on the attribute information F1 (S5).

When the terminal 2 is the first classification, the advertising distribution device 1 distributes the detailed information A1x regarding the product etc. of the advertiser X to the terminal 2 based on the selection information F2 being detected (S6). The advertising distribution device 1 generates the first billing information 6a (100 yen) based on the terminal 2 being the first classification and the detailed information A1x being distributed (S7).

On the other hand, when the terminal 2 is the second classification, the advertising distribution device 1 distributes the intermediate page information A2x regarding the product etc. of the advertiser X to the terminal 2 based on the selection information F2 being detected (S8). The advertising distribution device 1 generates the second billing information 6b (20 yen) based on the terminal 2 being the second classification and the intermediate page information A2x being distributed (S9).

When the terminal 2 clicks (selects) the intermediate page information A2x (S10), the advertising distribution device 1 detects the selection information F20 thereof (S11). The advertising distribution device 1 distributes the detailed information A1x regarding the product etc. of the advertiser X to the terminal 2 based on the selection information F20 being detected (S12). The advertising distribution device 1 generates the third billing information 6c (80 yen) based on the terminal 2 being the second classification and the detailed information A1x being distributed (S13).

One of embodiments of the present invention has been described above. The present invention is not limited to these embodiments and various variations and modifications can be made within the spirit and scope of the present invention.

It is not particularly limited which of the detection unit P1, the acquisition unit P2, the classification unit P3, the distribution unit P4, and the billing unit P5 performs which function described above, or which of the detection unit P1, the acquisition unit P2, the classification unit P3, the distribution unit P4, and the billing unit P5 executes which process. In any event, the CPU 1a merely has to perform the above-described functions or execute the processes by execution of the advertising distribution program P.

The advertising information database DB1 and the billing information database DB2 have been described above as separate databases, but are not limited to this. These databases may integrally constitute one database. A form of the database is not limited. When each of the information described above is associated, functions as a database are performed.

First Variation

In the above embodiment, an example has been described in which detailed information A1x is distributed from an advertising distribution device 1 to a terminal 2 based on an advertising information database DB1. However, detailed information 3b may be distributed from an advertiser server 3 when a classification of the terminal 2 is a first classification and a banner image Bx is selected. In this case, detailed information A1 does not need to be stored in the advertising information database Del. A concept in the present invention “a distribution unit distributes distribution information” includes not only a case where “a distribution unit distributes distribution information in an advertising distribution device oneself”, but also “a distribution unit causes another device, such as an advertiser server, to distribute distribution information in the device.” That is, distribution of the detailed information 3b by the advertiser server 3 to the terminal 2 based on a command (a request signal) from a distribution unit P4 is also one form of “a distribution unit distributes distribution information”.

That is, in a situation where the terminal 2 is classified into the first classification, when the banner image Ex is selected, the distribution unit P4 of the advertising distribution device 1 does not need to distribute distribution information such as the detailed information A1, and may transmit to the advertiser server 3 the request signal requesting distribution of the detailed information A1.

In the above embodiment, a case of two classifications including a first classification and a second classification has been described, but the classification of the terminal 2 based on attribute information F1 may be three or more. In this case, a plurality of kinds of intermediate page information A2 may be prepared corresponding to each classification.

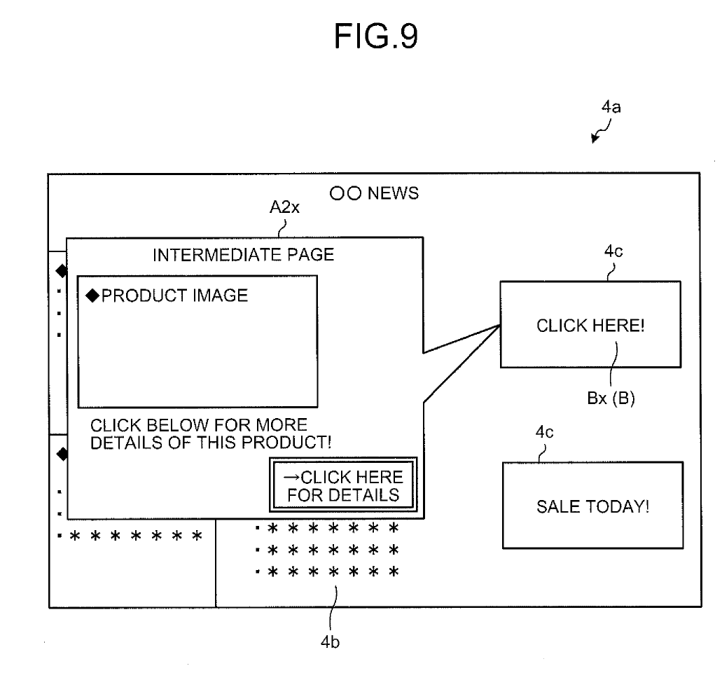

As illustrated in FIG. 9, in a case where the classification of the terminal 2 is the second classification, when the banner image Bx is clicked, content of intermediate page information A2x may be displayed as-is on a display screen 2a as a pop-up window 7 without making a page transition from a news site 4a.

Second Variation

In the above embodiment, an example has been described in which attribute information F1 regarding a terminal 2 is action history information, such as a user's Internet site browsing history and a product purchasing history, and is stored in the terminal 2. Various information may however be considered as the attribute information F1.

For example, the attribute information F1 may be registration information regarding the terminal 2 (that is, regarding a user of the terminal 2), the registration information being stored in the terminal 2, stored in the advertising distribution device 1, or stored in a device different from the terminal 2 or the advertising distribution device 1. The registration information may be, for example, personal information, such as a user's address, sex, age, and a hobby. The different device herein may be a shopping server that runs an Internet shopping site or a social networking service (SNS) server that runs an SNS site.

An acquisition unit P2 may acquire the registration information regarding the terminal 2 as the attribute information F1 from the terminal 2, the advertising distribution device 1 oneself, or another device. A classification unit P3 may classify the terminal 2 based on the acquired registration information (information such as an address, sex, age, and a hobby).

The attribute information F1 may be a click rate of a banner image B regarding the terminal 2 (that is, regarding the user of the terminal 2). The click rate is an index value indicating how often the user clicks the banner image B, and is a proportion of the number of clicking the banner image B to the number of appearance of the banner image B (the number of display on the display screen 2a). For example, when the user clicks 30 times while the banner image B is displayed 100 times, the click rate is 30%.

The click rate indicates whether or not the user is a person who is apt to click the banner image B. An estimate can be made whether the user is a person who takes an interest in information regarding the banner image based thereon. Improvement in advertising effectiveness and advertising efficiency can be achieved by, for example, setting a classification criterion C at 50%, classifying the terminal 2 with the click rate of 50% or more into a first classification, and classifying the terminal 2 with the click rate of less than 50% into a second classification.

The click rate as the attribute information F1 may be calculated based on the total number of display of all the banner images B distributed to the terminal 2, or each click rate may be calculated for each advertiser (X, Y). A classification may be made based on the click rate about the advertiser X when the banner image Bx is clicked, and a classification may be made based on the click rate about the advertiser Y when the banner image By is clicked.

The present invention also includes the following purport.

An information distribution device includes a detection unit for detecting that predetermined display information displayed on a display screen of a terminal is selected, an acquisition unit for acquiring attribute information related to the terminal, and a distribution unit for changing a distribution mode depending on the attribute information and distributing distribution information for displaying on the display screen when it is detected that the predetermined display information is selected.

After the detection unit detects that the display information is selected, the distribution mode can be changed depending on the attribute information related to the terminal. Accordingly, different distribution information can be distributed depending on the attribute information. In addition, the distribution information may be or may not be distributed depending on the attribute information. That is, intent and an action tendency of a user who owns the terminal can automatically be estimated, and after the user selects display information, such as a banner image, improvement in advertising effectiveness and improvement in advertising efficiency may be achieved for each user based on the estimated intent and the action tendency.

“Advertising distribution with high advertising effectiveness” herein mainly denotes intensive advertising distribution to a user who is apt to contribute to purchasing of a product etc. related to the advertisement. “Advertising distribution with high advertising efficiency” mainly denotes advertising distribution with a high cost reduction effect to reduce useless advertising distribution to a user who is unlikely to contribute to purchasing of a product etc. related to the advertisement.

For example, after an advertising banner is selected, detailed information can be distributed quickly to a user, and intermediate information (an intermediate page) for reconfirming browsing of the detailed information can be distributed to another user. Appropriate distribution information can be distributed depending on an attribute of the user, such as intent and an action history.

“A distribution destination of the distribution information” herein is eventually the terminal. That is, the distribution information is eventually displayed on the display screen of the terminal. The direct distribution destination of the distribution unit is not limited to the terminal but may be another device, such as a relay media server that transmits the distribution information to the terminal. The attribute information may be acquired from the terminal or from another computer. For example, the attribute information may be browsing history information, such as cookie information stored in the terminal, and may be the registration information (such as an address, sex, and age information) stored in the information distribution device or another computer in relation to the terminal. “Changing a distribution mode” includes a case of distributing different distribution information and a case of distributing or not distributing distribution information.

The attribute information may include the click rate of the predetermined display information.

The click rate is information that indicates a proportion of selecting display information, and is, for example, a numerical value obtained by dividing the number of selection of the display information by the number of display of the display information. A higher click rate of the terminal denotes that the user selects the display information with a higher probability. A lower click rate of the terminal denotes that the user seldom selects the display information. Both high advertising effectiveness and efficient advertising distribution can be achieved by immediately displaying the detailed information in the terminal with a high click rate when the display information is selected, and displaying the intermediate page in the terminal with a low click rate.

The attribute information as the click rate of the predetermined display information may be collected and stored by the information distribution device, and may be collected and stored by a device other than the information distribution device (for example, a media server that transmits content information and an advertiser server that provides an advertiser site).

The attribute information may include the action history information regarding the terminal.

The action history information is information regarding a past action of the user of the terminal, and includes, for example, the browsing history information of an Internet site by the user and the product purchasing history information in an Internet shop. It is possible to estimate in what kind of product and information the user takes a high interest based on the user's browsing history and purchasing history. Based on the estimate, the intermediate page can be displayed after selection of the predetermined display information, or the detailed information can be displayed without displaying the intermediate page.

The attribute information may be stored in the terminal, may be stored in the information distribution device, or may be stored in a device other than the information distribution device (for example, the media server that transmits content information and the advertiser server that provides the advertiser site).

The attribute information can also include the registration information regarding the terminal besides the click rate of the predetermined display information and the action history information regarding the terminal. The registration information regarding the terminal is information regarding the user of the terminal, such as an address, sex, age, and a hobby. These pieces of registration information may be stored in the terminal, may be stored in the information distribution device, or may be stored in a device other than the information distribution device (for example, the media server that transmits content information and the advertiser server that provides the advertiser site).

It is possible to estimate in what kind of product and information the user takes a high interest based on the registration information regarding the terminal. Based on the estimate, the intermediate page can be displayed after selection of the predetermined display information, or the detailed information can be displayed without displaying the intermediate page.

The information distribution device may further include a classification criterion that is a determination criterion for classifying the terminal, and a classification unit for classifying the terminal into at least the first classification and the second classification based on a comparison between the attribute information and the classification criterion. The distribution unit may distribute the second distribution information as the distribution information when the terminal is classified into the second classification. The distribution unit may distribute the first distribution information different from the second distribution information as the distribution information or may not distribute the distribution information when the terminal is classified into the first classification.

Since the classification criterion is included, the determination criterion for changing the distribution mode for each terminal is clear. Since the terminal is classified based on the comparison between the classification criterion and the attribute information, and the distribution mode is changed depending on the classification, the change of the distribution mode depending on the classification of the terminal can be reliably performed.

The detection unit detects that the second distribution information displayed on the display screen is selected, and the distribution unit may distribute the first distribution information when it is detected that the second distribution information is selected.

Since the first distribution information is distributed after the detection unit detects that the second distribution information is selected, the first distribution information can be appropriately distributed according to intent of the user who owns the terminal. For example, the intermediate information for reconfirming browsing of the detailed information can temporarily be distributed to a user with whom reconfirmation should be made whether or not the detailed information regarding the advertising banner is browsed. The detailed information can be distributed based on the intermediate information being selected again. Depending on the user's attribute, the detailed information can be distributed after reconfirming the user's intent.

The information distribution device may further include a billing unit for generating first billing information indicating a first billing amount based on distribution of the first distribution information when the terminal is classified into the first classification, and for generating second billing information indicating a second billing amount based on distribution of the second distribution information when the terminal is classified into the second classification.

Billing information based on distribution of the first distribution information (the first billing information) and billing information based on distribution of the second distribution information (the second billing information) can be generated as separate billing information. A billing pattern can be changed depending on the intent and the attribute of the user. Specifically, for example, the billing amount indicated by the second billing information can be set to be smaller than the billing amount indicated by the first billing information. A financial burden on the advertiser accompanying distribution of the intermediate information can be reduced by making the billing to the advertiser when the second distribution information is distributed to the user's terminal smaller than the billing to the advertiser when the first distribution information is distributed.

The billing unit may generate third billing information indicating a third billing amount based on a difference between the first billing amount and the second billing amount based on distribution of the first distribution information when the terminal is classified into the second classification.

The first billing amount minus the second billing amount can equal the third billing amount (that is, the first billing amount is the sum of the second billing amount and the third billing amount). Even when the terminal is classified into the first classification or into the second classification, the billing amount when the first distribution information is eventually distributed can be made a common amount. For example, the burden on the advertiser can be reduced by making the billing amount at the time of distribution of the intermediate information a smaller amount, and fairness of the billing amount for advertising effectiveness is assured by making the billing amount when the detailed information is eventually distributed a common amount regardless of presence of the intermediate information distribution.

The information distribution method causes a computer to perform the steps of: detecting that the predetermined display information displayed on the display screen of the terminal is selected, acquiring the attribute information related to the terminal, and changing the distribution mode depending on the attribute information and distributing the distribution information for displaying on the display screen when it is detected that the predetermined display information is selected.

Each unit described herein, that is, each of the detection unit, the acquisition unit, the classification unit, the distribution unit, and the billing unit is a concept of a function to be performed by a CPU as a main portion of the information distribution device (a computer), and is not a concept of a physical module etc. In addition, these can be interpreted as a detection unit, an acquisition unit, a classification unit, a distribution unit, and a billing unit as appropriate.

After the user selects display information such as the banner image, an automatic estimate of the user's intent allows distribution information different for each user to be distributed based on the estimated intent.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information distribution device comprising:
a detection unit configured to detect that predetermined display information displayed on a display screen of a terminal is selected;
an acquisition unit configured to acquire attribute information related to the terminal; and
a distribution unit configured to change a distribution mode depending on the attribute information and distributing distribution information for displaying on the display screen when it is detected that the predetermined display information is selected.

2. The information distribution device according to claim 1, wherein the attribute information includes a click rate of the predetermined display information.

3. The information distribution device according to claim 1, wherein the attribute information includes action history information regarding the terminal.

4. The information distribution device according to any one of claims 1, further comprising:
a classification criterion that is a determination criterion for classifying the terminal; and
a classification unit configured to classify the terminal into at least a first classification and a second classification based on a comparison between the attribute information and the classification criterion, wherein
the distribution unit distributes second distribution information as the distribution information when the terminal is classified into the second classification, and distributes first distribution information different from the second distribution information as the distribution information or does not distribute distribution information when the terminal is classified into the first classification.

5. The information distribution device according to claim 4, wherein the detection unit detects that the second distribution information displayed on the display screen is selected, and the distribution unit distributes the first distribution information when it is detected that the second distribution information is selected.

6. The information distribution device according to claim 4, further comprising a billing unit configured to generate first billing information indicating a first billing amount based on distribution of the first distribution information when the terminal is classified into the first classification, and to generate second billing information indicating a second billing amount based on distribution of the second distribution information when the terminal is classified into the second classification.

7. The information distribution device according to claim 6, wherein the billing unit generates third billing information indicating a third billing amount based on a difference between the first billing amount and the second billing amount based on distribution of the first distribution information when the terminal is classified into the second classification.

8. An information distribution method for causing a computer to perform:
detecting that predetermined display information displayed on a display screen of a terminal is selected;
acquiring attribute information related to the terminal; and
changing a distribution mode depending on the attribute information and distributing distribution information for displaying on the display screen when it is detected that the predetermined display information is selected.
